(19) United States
(12) Patent Application Publication
(10) Pub. No.: US 2006/0159606 A1
(43) Pub. Date: Jul. 20, 2006

(54) Exhaust gas cleaning technique, and relevant system, and the chemical composition of the scrubbing fluid, particularly suited for motor vehicles

(76) Inventor: Domenico Napoleone, Roma (IT)

Correspondence Address: BREINER & BREINER, L.L.C., P.O. BOX 19290, ALEXANDRIA, VA, 22320-0290, US

(21) Appl. No.: 10/545,408

(22) PCT Filed: Feb. 27, 2004
(86) PCT No.: PCT/IT04/00089

§ 371 Date: Aug. 12, 2005

(30) Foreign Application Priority Data
Feb. 28, 2003 (IT) RM2003 A 000087

(51) Int. Cl. B01D 53/94

(52) U.S. Cl. 423/212

(57) ABSTRACT

This patent relates to an exhaust gas cleaning technique, and relevant system, and the chemical composition of the scrubbing fluid, particularly suited for motor vehicles, whose operating principle envisages the scrubbing of the exhaust gas produced by the engine and the disposal of the pollutants collected during the scrubbing process, and, in particular, in which the scrubbing liquid is composed of a detergent, for example acetic acid with acidity of 7.1%, in quantities of between 30 and 200 ml (ordinary vinegar); an antioxidant, for example citric acid salts, in quantities of between 0.1 and 100 g; a catalyst for seizing the pollutants contained in the fumes, for example pure cellulose in quantities of between 0.03 and 100 g; deionised water, in quantities of 15.0 l.

### BACKGROUND OF ART

It is well known that air pollution is caused by the gases released into the atmosphere, the most harmful of which are those produced by human activities: heating systems, vehicle exhausts, manufacturing plants, which release huge amounts of gas into the atmosphere each year, mostly concentrated in cities and industrial areas.

The safety levels of pollutant gases in the air—measured in parts per million (abbreviated as ppm, 1 ppm being one part in a million parts of air)—are 100 ppm of carbon oxides, 25 ppm of nitrogen oxides, 10 ppm of sulphur dioxide, 3.3 ppm of fluorides, 1 ppm of chlorine and nitrogen, and 0.5 ppm of hydrogen fluoride and formaldehyde. Petroleum products, and benzpyrene in particular, are especially harmful because slight traces are enough because small traces of these substances tend to build up in animal and vegetable tissues. Furthermore, the sunlight favours the reaction of the gases and combustion products released into the atmosphere, with the production of other dangerous substances.

Air pollution increases dramatically in situations of “thermal inversion”, in which a layer of warm air (an inversion layer) lies over a layer of cool air. The absence of wind circulation prevents pollution near the earth's surface from escaping, which means that any pollutants emitted accumulate in the trapped air and form what we call “smog”.

Various emissions control solutions have been attempted to remedy the aforementioned situation; these can be of a prescriptive nature, for example, by ordering cars off the roads when the pollution-monitoring units record alarming and harmful rates of air pollutants in the air; or technological solutions, such as the adoption of gas purifiers, catalytic converters combined with the use of lead-free petrol, et cetera. Unfortunately, none of these solutions actually solve the problem, because the catalytic converters still emit polluting gases until the converter reaches its operating temperature, which is very high, and in cities, where average trips tend to be short and stop-and-go driving is widespread, due to heavy traffic and traffic lights, a catalytic converter doesn't even have the chance of reaching its operating temperature and cars, therefore, continue to emit heavily polluting gases. To which we must add the fact that useless catalytic converters, when removed and replaced, cannot be recycled and only increase environmental pollution. Tests have shown that after heavy rainfalls air pollution drops drastically, because the rain “washes” the atmosphere, causing the pollutants to precipitate to the ground.

A previous patent by the same holder describes a technique, and relevant system, for purifying exhaust gases, particularly suited to motor vehicles, whose operating principle envisages the scrubbing of the exhaust gases produced by the engine and the disposal of the pollutants collected during the scrubbing process.

This patent application details the chemical composition of the scrubbing liquid and certain improvements to the technique and system to improve their efficiency.

For a better understanding of the present invention, following is a description of the system referred to in the previous patent, in which the gases produced by a motor engine, or the like, are cooled to reduce their volume and made to pass inside a hood with spaces within which there circulates a liquid, the pipes of the hood inside which the gases are made to pass are provided with fins arranged and oriented so as to impart a spiral movement on the gas; from the cooling hood the gas passes into a cylinder containing a coil with nozzles placed at regular intervals and at a certain angle; the coil is connected by a pipe to a pump that feeds a liquid from a tank to the nozzles on the coil, which spray a pressurised liquid in a direction such as to maintain and heighten the spiral movement of the gas. The liquid passes through the gas stripping it of the pollutants it contains.

The cylinder in which the gases pass and undergo the first scrubbing is connected—by means of a carter provided with longitudinal and sinusoidal fins, which further reduce the gas pressure—to a second cylinder, inside which the gas undergoes a second scrubbing, by a semi-circular shower placed near the inlet and spraying the remainder of the liquid employed in the first cylinder; immediately after the second scrubbing the gas is filtered by a filter placed lengthwise and crosswise to the axis of the cylinder, and finally expelled. The scrubbing liquid is recovered by means of a pump and sent to a cooling radiator, it is then filtered by an active carbon filter and stored in the tank from which it is fed to the first cylinder to start the cycle anew. An essential feature of the correct operation of the active carbon filter of the lowering of the scrubbing liquid's temperature below the evaporation temperature of the volatile pollutants.

### DESCRIPTION OF THE PREFERRED EMBODIMENT

In this invention the scrubbing liquid is composed of:

a) a detergent, for example acetic acid with acidity of 7.1%, in quantities of between 30 and 200 ml (ordinary vinegar);

b) an antioxidant, for example citric acid salts, in quantities of between 0.1 and 100 g;

c) a catalyst for seizing the pollutants contained in the fumes, for example pure cellulose in quantities of between 0.03 and 100 g;

d) deionised water, in quantities of 15.0 l.

In the preferred embodiment of this invention, the quantities of the various components of the scrubbing liquid will be as follows:

| | | |
|---|---|---|
| Detergent: Vinegar with 7.1% acidity | 100 | ml |
| Antioxidant: Citric acid salts | 3.00 | g |
| Catalyst: pure cellulose | 0.7 | g |
| Deionised water | 15.00 | l |

The active carbon filter contains between 400 and 1000 g of active carbon.

The dehydrating chemical action of the active carbon is renewed by the effect of the acids contained in the exhaust gases (sulphur dioxide and others), thus increasing the adsorption of the active carbon.

Heat variation within a range of between 45 and 75° C. increases the pH variation determined by the acetic acid contained in the scrubbing solution and facilitates the absorption of the other changeable substances, together with the variation of viscosity of the cellulose. The citric acid helps to maintain the correct balance between oxidant and antioxidant, causing the breaking of the crystal openings of the nanophores of the active carbon.

In order to ensure the system's efficiency under all conditions there is a de-freezing system, i.e. a resistance-based-system, in which the resistances are activated automatically when the outside temperature drops below a certain value, thus heating the system and, in particular, the pipes.

In order to control the system, there are thermometers, warning lights and alarms connected to the system, and preferably located inside the vehicle, in a visible position, and in particular:

a flow switch for controlling the scrubbing liquid;

a flow switch for controlling the liquid of the active carbon filter;

a thermometer for controlling the temperature of the incoming gas;

a thermometer for controlling the temperature of the gas-scrubbing liquid;

a thermostat for controlling the heat range and related cooling speed of the liquid inside the radiator;

a thermostat for activating the de-freezing system;

an on/off light for the apparatus;

an indicator light for verifying the interconnection of the gas on apparatus;

an indicator light for verifying the interconnection of the gas off apparatus;

a warning light for signalling the apparatus in bypass due to lack of liquid; blocked filters; excessive temperature of the active carbon;

a warning light for liquid saturation.

The principles of the invention are described hereinabove by describing the construction and operation of a preferred embodiment. It is to be remembered that this exemplary embodiment can be modified or changed without departing from the spirit or scope of the invention as defined by the following claims.

1. An exhaust gas cleaning technique, and relevant system, and the chemical composition of the scrubbing fluid, particularly suited for motor vehicles, in which the exhaust gas produced by a motor engine, or the like, to which a spiral movement is imparted, is cooled and then scrubbed with a liquid compound containing cellulose, or the like, and other substances capable of catalysing the pollutants and, after a second scrubbing brief process, the gas is then filtered, the pollutants mixed with the liquid compound, gathered and filtered, and the purified liquid compound recirculated to be used in the next scrubbing cycle wherein the scrubbing liquid is composed as follows:
a) a detergent, for example acetic acid with acidity of 7.1%, in quantities of between 30 and 200 ml (ordinary vinegar);
b) an antioxidant, for example citric acid salts, in quantities of between 0.1 and 100 g;
c) a catalyst for seizing the pollutants contained in the fumes, for example pure cellulose in quantities of between 0.03 and 100 g;
d) deionised water, in quantities of 15.0 l.

2. An exhaust gas cleaning technique, and relevant system, and the chemical composition of the scrubbing fluid, particularly suited for motor vehicles described in claim 1, wherein the percentage composition of the scrubbing liquid is as follows:

| | | |
|---|---|---|
| Detergent: Vinegar with 7.1% acidity | 100 | ml |
| Antioxidant: Citric acid salts | 3.00 | g |
| Catalyst: pure cellulose | 0.7 | g |
| Deionised water | 15.00 | l |

The active carbon filter contains between 400 and 1000 g of active carbon.

3. An exhaust gas cleaning technique, and relevant system, and the chemical composition of the scrubbing fluid, particularly suited for motor vehicles described in the preceding claims wherein a de-freezing system is provided for, i.e. a resistance-based system, in which the resistances are activated automatically when the outside temperature drops below a certain value, thus heating the system and, in particular, the pipes.

4. An exhaust gas cleaning technique, and relevant system, and the chemical composition of the scrubbing fluid, particularly suited for motor vehicles described in the preceding claims wherein, to control the system, there are thermometers, warning lights and alarms connected to the system, and preferably located inside the vehicle, in a visible position, and in particular:
a flow switch for controlling the scrubbing liquid;
a flow switch for controlling the liquid of the active carbon filter;
a thermometer for controlling the temperature of the incoming gas;
a thermometer for controlling the temperature of the gas-scrubbing liquid;
a thermostat for controlling the heat range and related cooling speed of the liquid inside the radiator;
a thermostat for activating the de-freezing system;
an on/off light for the apparatus;
